(19) United States
(12) Patent Application Publication
(10) Pub. No.: US 2008/0147361 A1
(43) Pub. Date: Jun. 19, 2008

(54) METHODS AND APPARATUS TO MONITOR SYSTEM HEALTH

(76) Inventor: Daniel H. Miller, Charlottesville, VA (US)

Correspondence Address: GENERAL ELECTRIC CO.;GLOBAL PATENT OPERATION, 187 Danbury Road, Suite 204, Wilton, CT, 06897-4122, US

(21) Appl. No.: 11/611,645

(22) Filed: Dec. 15, 2006

(51) Int. Cl. G06F 17/10

(52) U.S. Cl. 703/2

(57) ABSTRACT

A method of monitoring a system includes identifying a plurality of subsystems associated with the system. Each of the plurality of subsystems is configured to receive at least one input signal and at least one output signal and has at least one predetermined limit. The method also includes generating a plurality of subsystem models by generating at least one subsystem model of each of the plurality of subsystems. Each of the subsystem models are at least partially formed from the first input signals and the first output signals. The method further includes generating at least one system model having at least one predetermined limit by integrating the plurality of subsystem models. At least one of the subsystem models is bounded by at least one predetermined limit of at least one other subsystem model, and/or at least one predetermined limit of the system model.

### BACKGROUND OF THE INVENTION

The present invention relates generally to predictive modeling and more particularly, to predictive modeling of systems using a plurality of mathematical models.

Many known macroscopic processes, or systems, are defined by a plurality of smaller, independent and interrelated processes, or subsystems. Such systems include, but are not limited to, automotive production lines, electrical power generation facilities, locomotives, and chemical production plants. Such subsystems include, but are not limited to, components such as data processors, electric motors, and atmospheric control devices. Monitoring such systems and the associated subsystems facilitates product quality, system availability, and decreasing component maintenance costs. Many known facilities use some form of condition monitoring and/or predictive maintenance methods and apparatus to monitor such systems and the associated subsystems.

Some known condition monitoring and predictive maintenance methods and systems attain data and perform analyses on specific systems and subsystems. However, some interrelationships between systems and subsystems are not always accounted for and such interrelationships may mask conditions that warrant evaluation.

### BRIEF DESCRIPTION OF THE INVENTION

In one aspect, a method of monitoring a system is provided. The method includes identifying a plurality of subsystems associated with the system. Each of the plurality of subsystems is configured to receive at least one input signal and at least one output signal and has at least one predetermined limit. The method also includes generating a plurality of subsystem models by generating at least one subsystem model of each of the plurality of subsystems. Each of the subsystem models are at least partially formed from the first input signals and the first output signals. The method further includes generating at least one system model having at least one predetermined limit by integrating the plurality of subsystem models. At least one of the subsystem models is bounded by at least one predetermined limit of at least one other subsystem model, and/or at least one predetermined limit of the system model.

In another aspect, a method of monitoring a system is provided. The method includes identifying a plurality of subsystems associated with the system. Each of the plurality of subsystems is configured to receive at least one input signal and at least one output signal and has at least one predetermined limit. The method also includes generating a plurality of subsystem models by generating at least one subsystem model of each of the plurality of subsystems. Each of the subsystem models are at least partially formed from the first input signals and the first output signals. The method further includes coupling at least one machine learning scheme in data communication with at least one of a system model and/or at least one of the plurality of subsystem models. The method also includes generating at least one system model having at least one predetermined limit by integrating the plurality of subsystem models. At least one of the subsystem models is bounded by at least one predetermined limit of at least one other subsystem model, and/or at least one predetermined limit of the system model.

In a further aspect, a system health monitor is provided. The monitor includes a plurality of subsystem models formed to at least partially represent each of a plurality of subsystems. A first subsystem model has a first predetermined limit and a second subsystem model has a second predetermined limit. The monitor also includes at least one system model at least partially formed by the plurality of subsystem models. The at least one system model at least partially represents a system formed by the plurality of subsystems. The at least one system model has a third predetermined limit, wherein the first predetermined limit, the second predetermined limit, and the third predetermined limit cooperate to form at least one of a fourth predetermined limit of the first subsystem model, a fifth predetermined limit of the second subsystem model, and/or a sixth predetermined limit of the system model.

### BRIEF DESCRIPTION OF THE DRAWINGS

FIG. 1 is a block diagram of an exemplary system health monitoring scheme; and

FIG. 2 is a block diagram of an alternative system health monitoring scheme.

### DETAILED DESCRIPTION OF THE INVENTION

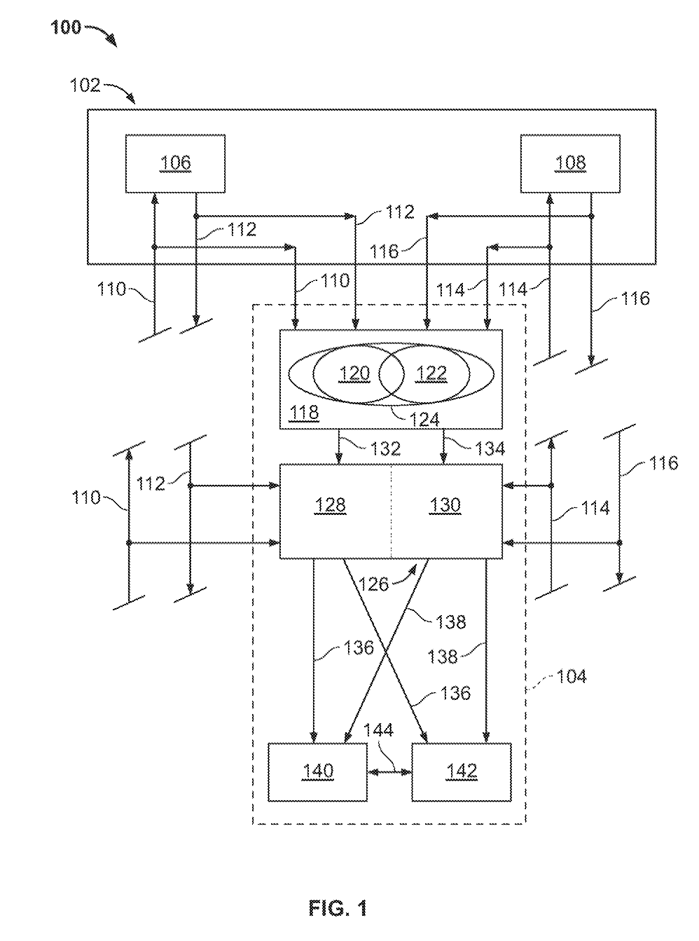

FIG. 1 is a block diagram of an exemplary system health monitoring scheme 100. Scheme 100 includes at least one system 102 and at least one system health monitor 104.

System 102 is any system that is compatible with monitor 104 as described herein including, but not limited to, process monitoring and control schemes. Also, system 102 is any machine that includes, but is not limited to, a motor, generator, pump and fan. Furthermore, system 102 is a production process that includes, but is not limited to, electric power generation and chemical manufacturing. Generally, any complex process, scheme and machine may be logically differentiated into a plurality of subsystems. Therefore, system 102 is logically differentiated into a plurality subsystems wherein only a first subsystem 106 and a second subsystem 108 are illustrated. System 102 includes any number of subsystems that facilitates operation of scheme 100 as described herein.

First subsystem 106 is coupled in data communication with at least one other component (not shown) within either system 102 or another system (not shown). First subsystem 106 is coupled via at least one data signal input conduit 110 and at least one data signal output conduit 112. First subsystem 106 is configured to receive any number of input data signals and transmit any number of output data signals (neither shown). Similarly, second subsystem 108 is coupled in data communication with at least one other component (not shown) within either system 102 or another system (not shown). Second subsystem 108 is coupled via at least one data signal input conduit 114 and at least one data signal output conduit 116. Second subsystem 108 is configured to receive any number of input data signals and transmit any number of output data signals (neither shown).

System health monitor 104 is an electronic computer-based assembly. Monitor 104 includes at least one processor and a memory, at least one processor input channel, at least one processor output channel, and may include at least one computer (none shown). As used herein, the term computer is not limited to just those integrated circuits referred to in the art as a computer, but broadly refers to a processor, a microcontroller, a microcomputer, a programmable logic controller (PLC), an application specific integrated circuit, and other programmable circuits (none shown), and these terms are used interchangeably herein. In the exemplary embodiment, memory may include, but is not limited to, a computer-readable medium, such as a random access memory (RAM) (none shown). Alternatively, a floppy disk, a compact disc—read only memory (CD-ROM), a magneto-optical disk (MOD), and/or a digital versatile disc (DVD) (none shown) may also be used. Also, in the exemplary embodiment, additional input channels (not shown) may be, but not be limited to, computer peripherals associated with an operator interface such as a mouse and a keyboard (neither shown). Alternatively, other computer peripherals may also be used that may include, for example, but not be limited to, a scanner (not shown). Furthermore, in the exemplary embodiment, additional output channels may include, but not be limited to, an operator interface monitor (not shown).

Processors for monitor 104 process information transmitted from a plurality of electrical and electronic devices that may include, but not be limited to, speed and power transducers. RAM and storage device2 store and transfer information and instructions to be executed by the processor. RAM and storage devices can also be used to store and provide temporary variables, static (i.e., non-changing) information and instructions, or other intermediate information to the processors during execution of instructions by the processors. Instructions that are executed include, but are not limited to, resident conversion and/or comparator algorithms. The execution of sequences of instructions is not limited to any specific combination of hardware circuitry and software instructions.

In the exemplary embodiment, system health monitor 104 includes a system and subsystem model module 118 coupled in data communication with subsystems 106 and 108 via data signal conduits 110, 112, 114 and 116. Module 118 is configured to receive the input and output signals associated with first subsystem 106 via data signal conduits 110 and 112. Module 118 is also configured to form at least one first subsystem model 120 of first subsystem 106 via a first set of input and output signals. Model 120 is a virtual, or mathematical, model of at least a portion of subsystem 106 formed by a predetermined number of input signals and output signals that are received by module 118. In the exemplary embodiment, model 120 models a predetermined portion of subsystem 106 and not necessarily all of subsystem 106 as is described further below.

Similarly, module 118 is configured to receive the input and output signals associated with second subsystem 108 via data signal conduits 114 and 116. Module 118 is also configured to form at least one second subsystem model 122 of second subsystem 108 via a first set of input and output signals. Model 122 is a virtual, or mathematical, model of at least a portion of subsystem 108 formed by a predetermined number of input signals and output signals that are received by module 118. In the exemplary embodiment, model 122 models a predetermined portion of subsystem 108 and not necessarily all of subsystem 108 as is described further below.

Moreover, module 118 is configured to form models 120 and 122 with their associated predetermined limits such that the associated limiting characteristics that interrelate to each other within subsystems 106 and 108 facilitate forming additional and/or modified predetermined limits for each of subsystem models 120 and 122, thereby more accurately modeling subsystems 106 and 108.

Furthermore, module 118 is configured to form models 120 and 122 such that they form a system model 124 that includes the features of both subsystem models 120 and 122. System model 124 represents at least a portion of system 102 wherein system 102 characteristics are formed as a function of the interrelated and not interrelated characteristics of subsystems 106 and 108 as well as the inherent characteristics of system 102. Therefore, system 102 includes at least one limiting characteristic and system model 124 includes at least one predetermined limit associated with system 102.

The predetermined limits of each subsystem model and the system model predetermined limits form an interrelationship that more approximately mirrors the interrelationship of subsystems 106 and 108 within larger system 102. Therefore, further additional and/or further modified predetermined limits for each of subsystem models 120 and 122 and system model 124 are formed. These further additional and/or further modified predetermined limits at least partially form models 120, 122 and 124 as models of interest. Once models 120, 122 and 124 are substantially fully formed as the models of interest, they continue to reside within module 118.

Monitor 104 also includes at least one comparison module 126 that includes at least one comparison algorithm (not shown) residing in each of a first subsystem comparator 128 and a second subsystem comparator 130. Each of comparators 128 and 130 are configured to receive a first subsystem model output signal 132 and a second subsystem model output signal 134, respectively. Such signals 132 and 134 substantially represent associated subsystem models 120 and 122. Moreover, comparator 128 is configured to receive inputs and outputs via conduits 110 and 112 that are representative of recent subsystem 106 operation. Similarly, comparator 130 is configured to receive inputs and outputs via conduits 114 and 116 that are representative of recent subsystem 108 operation. Furthermore, comparators 128 and 130 are configured to compare models 120 and 122 with the associated recent operational inputs and outputs. Moreover, comparators 128 and 130 are configured with predetermined differential values such that in the event a comparison of a subsystem model 120 and/or 122, respectively, that yields a value that is outside of a range defined by such predetermined differential values, at least one first subsystem failure signal 136 and/or at least one second subsystem failure signal 138 is generated.

In the exemplary embodiment, the data collected as the associated recent operational inputs and outputs is first stored in a storage device (not shown) for comparison at a later time, for example, during off-line operations. Storing the data in this manner for later comparison facilitates mitigating processing requirements during on-line data collection operations. Alternatively, the data is collected and stored and the comparison operations performed during any period that facilitates operation of scheme 100.

Monitor 104 further includes at least one notification module 140 that is configured to receive each of signals 136 and 138. Module 140 is further configured to generate a notification (not shown) to an operator of a subsystem failure. The notification may include, but not be limited to, audible alarms, energization of annunciator lamp (not shown), and highlighted line items on a computer terminal monitor (not shown). Such notification is expected to induce an operator to initiate research activities.

In the exemplary embodiment, monitor 104 also includes at least one optional statistical process control (SPC) module 142 that is also configured to receive each of signals 136 and 138. Module 142 is further configured with predetermined process evaluation algorithms and commands that enhance further diagnoses of the associated subsystem failure(s). Moreover, module 142 is coupled in data communication with notification module 140 via conduit 144 to exchange data that enhances operation of each module. For example, module 142 may decrease a number of false notifications by advanced analyses of suspected subsystem failures. Similarly, module 140 may initiate advanced analyses of suspected subsystem failures such that the resources of module 142 are not expended on non-alarming subsystem conditions. Alternatively, monitor 104 is configured without SPC module 142.

Scheme 100 is configured such that failure signals 136 and 138 are predictive in nature, that is, they predict that a potential failure within the associated subsystem(s) may be developing. Such predictive evaluations facilitate scheduling maintenance outages or shutdowns to troubleshoot, repair and/or replace the associated subsystem or system. The prediction accuracy is facilitated by predetermined values of data quality, amount of data collection, periodicity of data collection, and a frequency of data-to-model comparisons.

An exemplary method of monitoring system 102 includes identifying a plurality of subsystems that includes, at least, subsystems 106 and 108 associated with system 102. Each of the plurality of subsystems is configured to receive at least one input signal and at least one output signal and has at least one predetermined limit. The method also includes generating a plurality of subsystem models by generating at least one subsystem model that includes, at least, models 120 and 122, of each of subsystems 106 and 108, respectively. Each of subsystem models 120 and 122 are at least partially formed from the first input signals and the first output signals. The method further includes generating at least one system model 124 having at least one predetermined limit by integrating the plurality of subsystem models that includes, at least, models 120 and 122. At least one of the subsystem that includes, at least, model 120 is bounded by at least one predetermined limit of at least one other subsystem model that includes, at least, model 122 and/or at least one predetermined limit of system model 124.

During operation, system 102 is divided into at least two logical subsystems 106 and 108. First subsystem 106 receives a predetermined number of “first” input signals and transmits a predetermined number of “first” output signals via conduits 110 and 112, respectively, as a function of standard, nominal operation of system 102. Within the context of “training” monitor 104 (as described further below), the “first” input and output signals represent the first set of such signals admitted to module 118 for the purpose of creating at least one transfer function (not shown) that substantially represents correct operation of the associated portions of subsystem 106. Parameters of such first data sets of signals are predetermined to facilitate training operations and include, but are not limited to, duration of data gathering operations and a number of iterations of data collection activities. Similarly, second subsystem 108 receives a predetermined number of first input signals and transmits a predetermined number of first output signals via conduits 114 and 116, respectively. The input and output signals include, but are not limited to, computer-modeled data, test-induced system and subsystem signals, data collected during commissioning activities, and historically collected empirical data.

A first version of first subsystem model 120 is formed with at least one first predetermined limit (not shown) that represents at least one associated limiting characteristic of first subsystem 106. Similarly, a first version of second subsystem model 122 is formed with at least one second predetermined limit (not shown) that represents at least one associated limiting characteristic of second subsystem 108. Forming such models 120 and 122 are typically referred to as “training the system” in the art. Such training refers to creating mathematical models that substantially represent correct operation of the associated portions of subsystems 106 and 108. The limiting characteristics facilitate efficient and/or effective operation of the associated subsystems. Examples of subsystem limiting characteristics and subsystem model predetermined limits include, but are not limited to time, temperature, current, speed, voltage, pressure, and flow limits, as well as subsystem interrelationship interlocks and sequencing features. These predetermined limits at least partially define the associated subsystem models 120 and 122 such that, while, as discussed above, fully developed models of subsystems 106 and 108 may not have been formed, models 120 and 122 represent predetermined portions of associated subsystems 106 and 108, respectively at a predetermined point in their operational life, for example, but not limited to, initial commissioning.

In the event that a portion of either subsystem 106 and/or 108 is changed, for example, a modular component such as a pump is replaced or a limit is reconfigured, such initial data collection as described above may be performed again to “retrain the system”. Therefore, such retraining includes forming a new mathematical model of the predetermined portions of subsystems 106 and/or 108 that reflect correct operation of the reconfigured subsystems 106 and/or 108. Subsequent operations, as discussed further below, may also be performed.

Moreover, module 118 forms models 120 and 122 with their associated predetermined limits such that the associated limiting characteristics that interrelate to each other within subsystems 106 and 108 facilitate forming additional and/or modified predetermined limits for each of subsystem models 120 and 122, thereby more accurately modeling subsystems 106 and 108. Therefore, a second version of first subsystem model 120 is formed with at least one third predetermined limit (not shown) that includes additional predetermined limits and/or modified first predetermined limits as compared to the at least one first predetermined limit. The third at least one predetermined limit represents at least one associated limiting characteristic of first subsystem 106 as subsystem 106 interrelates with subsystem 108. Similarly, a second version of second subsystem model 122 is formed with at least one fourth predetermined limit (not shown) that includes additional predetermined limits and/or modified second predetermined limits as compared to the at least one second predetermined limit. The fourth at least one predetermined limit represents at least one associated limiting characteristic of second subsystem 108 as subsystem 108 interrelates with subsystem 106.

Furthermore, in the exemplary embodiment, module 118 forms models 120 and 122 such that they form a system model 124 that includes the features of both subsystem models 120 and 122. System model 124 represents at least a portion of system 102 wherein system 102 characteristics are formed as a function of the interrelated and not interrelated characteristics of subsystems 106 and 108 as well as the inherent characteristics of system 102. Therefore, system 102 includes at least one limiting characteristic and system model 124 includes at least one predetermined limit associated with system 102. Such formation and/or linking of subsystem models 120 and 122 to a broader system model 124 facilitates mathematically defining known interrelationships and dependencies between models 120, 122 and 124. Alternatively, wherein such known interrelationships and dependencies are not known to exist or are not desired to be modeled, such formation and/or linking is not performed.

The methods of generating subsystem model and system model predetermined limits are iterative. The predetermined limits of each subsystem model and the system model predetermined limits form an interrelationship that more approximately mirrors the interrelationship of subsystems 106 and 108 within larger system 102. Therefore, further additional and/or further modified predetermined limits for each of subsystem models 120 and 122 and system model 124 are formed. These further additional and/or further modified predetermined limits at least partially form models 120, 122 and 124 as models of interest.

Models 120, 122 and 124 do not necessarily completely define operation of associated subsystems 106 and 108 and system 102. In contrast, models 120, 122 and 124 are formed of a predetermined number of transfer functions necessary to model the predetermined characteristics of subsystems 106 and 108 and system 102. These predetermined characteristics typically are limited to those that define the predetermined components of subsystems 106 and 108 as positioned, configured and used within system 102. Therefore, processing resources within monitor 104 and processing latency are facilitated to be decreased. Moreover, monitor 104 design and engineering resources may be decreased, thereby facilitating a decrease in time and resources necessary to implement monitor 104 within scheme 100. Therefore, a total cost of ownership of monitor 104 is facilitated to be decreased.

Moreover, forming models 120, 122 and 124 do not require detailed, intimate knowledge of the associated operation of subsystems 106 and 108 and system 102 and their associated interrelationships. Such modeling of operations is typically referred to as “black box” modeling in the art. Such black box modeling facilitates ease of implementation of monitor 104 within scheme 100.

Models 120, 122 and 124 are substantially static and reside within module 118. Models 120, 122 and/or 124 may be modified as necessary with new input and output data as described above. Signal 132, that represents model 120, is generated within module 118 and is transmitted to comparator 128. Comparator 128 receives signal 132 as well as input and output signals associated with subsystem 106 via conduits 110 and 112, respectively, at predetermined times. Comparator 128 compares signal 132 with the input and output signals and uses at least one resident comparison algorithm to determine at least one difference value that represents changes in the value of the input and output signals between the formation of model 120 and the predetermined point in time. The difference values are compared to predetermined values that were input into comparator 128. Such predetermined values are either static or dynamic. In the event that the difference values are outside of a range defined by the predetermined values, notification signal 136 is generated within comparator 128 and is transmitted to notification module 140 and SPC module 142.

Similarly, signal 134, that represents model 122, is generated within module 118 and is transmitted to comparator 130. Comparator 130 receives signal 134 as well as input and output signals associated with subsystem 108 via conduits 114 and 116, respectively, at predetermined times. Comparator 130 compares signal 134 with the input and output signals and uses at least one resident comparison algorithm to determine at least one difference value that represents changes in the value of the input and output signals between the formation of model 122 and the predetermined point in time. The difference values are compared to predetermined values that were input into comparator 130. Such predetermined values are either static or dynamic. In the event that the difference values are outside of a range defined by the predetermined values, notification signal 138 is generated within comparator 130 and is transmitted to notification module 140 and SPC module 142.

In the exemplary embodiment, the data collected as the associated recent operational inputs and outputs is first stored in a storage device (not shown) for comparison at a later time, for example, during off-line operations. Storing the data in this manner for later comparison facilitates mitigating processing requirements during on-line data collection operations. Alternatively, the data is collected and stored and the comparison operations performed during any period that facilitates operation of scheme 100.

Notification module 140 receives failure signals 136 and/or 138 and informs an operator of a potential failure associated with subsystem 106 and/or 108. SPC module 142 also receives failure signals 136 and/or 138 and performs further diagnostic analyses.

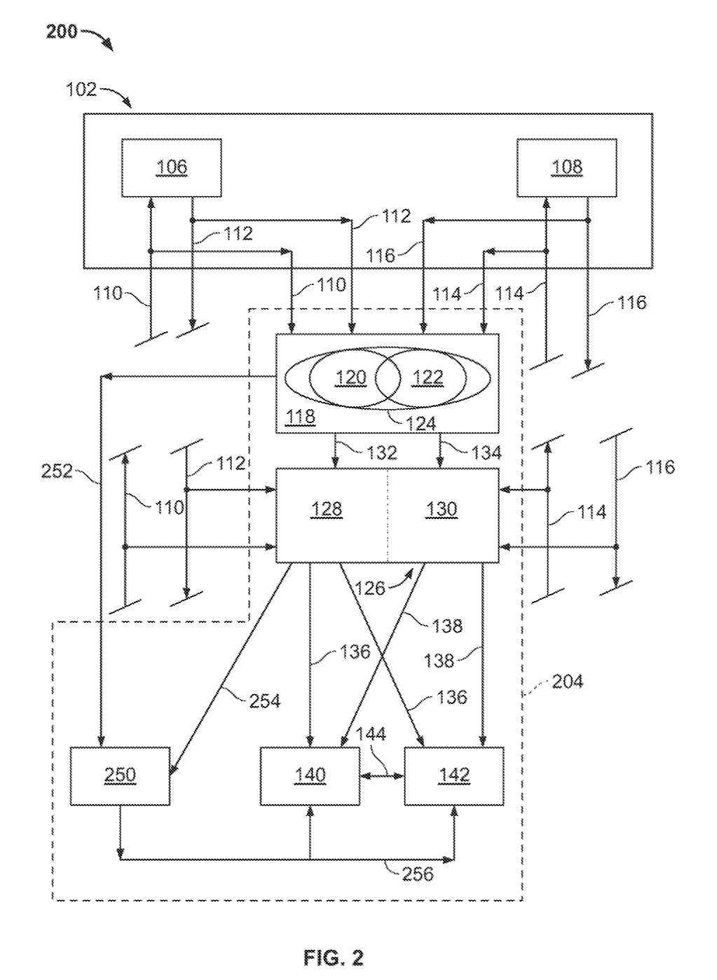

FIG. 2 is a block diagram of an alternative system health monitoring scheme 200. Scheme 200 is similar to scheme 100 with the exception that scheme 200 includes an alternative system health monitor 204. Monitor 204 is similar to monitor 104 with the exception that monitor 204 includes at least one machine learning scheme 250. In the exemplary embodiment, machine learning scheme 250 is a neural network. Alternatively, scheme 250 is any scheme that facilitates operation of monitor 204 as described herein. Machine learning scheme 250 is formed via methods known in the art and is coupled in data communication with system and subsystem model module 118 such that is receives signals 252. Signals 252 include first and second subsystem model output signals 132 and 134, respectively, and other historical data signals (not shown) that facilitate forming a historical database (not shown) of operational information within machine learning scheme 250.

Scheme 250 also receives signal 254 that includes first and second subsystem failure signals 136 and 138, respectively. Moreover, scheme 250 generates and transmits output signal 256 to notification module 140 and SPC module 142.

In this alternative embodiment, scheme 250 is trained during system 102 commissioning activities wherein monitor 204 is induced to form predictions based on models 120, 122 and 124. System 102 experts and subsystems 106 and 108 experts would be consulted to determine the veracity and accuracy of such predictions and scheme 250 is trained to reduce a number of false predictions. Alternatively, scheme 200, including scheme 250 is formed, configured, and fully trained by a manufacturer of system 102 in conjunction with system 102 prior to commissioning activities. An operator of scheme 200 can make further determinations with respect to scheme 250 post-commissioning training based on performance.

The methods and apparatus for monitoring system health as described herein facilitates operation of systems and their associated subsystems. Specifically, configuring a system health monitor of a system health monitoring scheme facilitates modeling such systems and subsystems to facilitate predictive failure analyses. More specifically, configuring the system health monitor as described herein facilitates diagnoses of potential subsystem failures while decreasing a number of false notifications by advanced analyses of such suspected failures. Moreover, the monitor initiates advanced analyses of suspected subsystem failures such that the resources of the monitor are not expended on non-alarming subsystem conditions and unnecessary system and subsystem modeling. Such configuration and predictive evaluations facilitate scheduling maintenance outages or shutdowns to troubleshoot, repair and/or replace the associated subsystem or system, thereby reducing the total cost of ownership of the system being monitored. Moreover, the method and equipment for monitoring systems as described herein facilitates reducing hardware procurement, installation, and configuration, therefore reducing capital and labor costs associated with installing such monitoring schemes.

Exemplary embodiments of system monitoring are described above in detail. The methods, apparatus and systems are not limited to the specific embodiments described herein nor to the specific illustrated monitoring schemes.

While the invention has been described in terms of various specific embodiments, those skilled in the art will recognize that the invention can be practiced with modification within the spirit and scope of the claims.

What is claimed is:

1. A method of monitoring a system, said method comprising:
identifying a plurality of subsystems associated with the system, wherein each of the plurality of subsystems is configured to receive at least one input signal and at least one output signal, wherein each of the plurality of subsystems has at least one predetermined limit;
generating a plurality of subsystem models by generating at least one subsystem model of each of the plurality of subsystems, wherein each of the subsystem models are at least partially formed from the first input signals and the first output signals; and
generating at least one system model having at least one predetermined limit by integrating the plurality of subsystem models, wherein at least one of the subsystem models is bounded by at least one of the following:
at least one predetermined limit of at least one other subsystem model; and
at least one predetermined limit of the system model.

2. A method in accordance with claim 1 wherein generating at least one system model having at least one predetermined limit by integrating the plurality of subsystem models comprises:
generating a first subsystem model of a first subsystem having a first predetermined limit;
generating a first subsystem model of a second subsystem having a second predetermined limit; and
generating a second subsystem model of the first subsystem having a third predetermined limit.

3. A method in accordance with claim 2 further comprising at least one of:
generating a second subsystem model of the second subsystem having a fourth predetermined limit; and
generating the system model having a system model predetermined limit.

4. A method in accordance with claim 3 further comprising iteratively generating the plurality of subsystem models and the at least one system model with predetermined limits.

5. A method in accordance with claim 1 wherein generating a plurality of subsystem models comprises:
at least partially forming a system health monitoring scheme;
coupling at least one input channel and one output channel in data communication with each subsystem;
coupling each input channel and each output channel in data communication with the system health monitoring scheme that includes the plurality of subsystem models; and
receiving a first input signal via each of the input signal conduits and a first output signal via each of the output signal conduits within the process health monitoring scheme.

6. A method in accordance with claim 1 further comprising:
transmitting a second input signal via each of the input signal conduits and a second output signal via each of the output signal conduits to a system health monitoring scheme that includes the plurality of subsystem models;
comparing each of the second input signals and each of the second output signals within the plurality of subsystem models; and
generating at least one notification signal if comparing the signals with the plurality of subsystem models indicates a variance exceeding a predetermined value.

7. A method in accordance with claim 6 further comprising forming at least one statistical process control algorithm within the system health monitoring scheme configured to enhance an information content of the at least one notification signal.

8. A method of monitoring a system, said method comprising:
identifying a plurality of subsystems associated with the system, wherein each of the plurality of subsystems is configured to receive at least one input signal and at least one output signal, wherein each of the plurality of subsystems has at least one predetermined limit;
generating a plurality of subsystem models by generating at least one subsystem model of each of the plurality of subsystems, wherein each of the subsystem models are at least partially formed from the first input signals and the first output signals;
coupling at least one machine learning scheme in data communication with at least one of a system model and at least one of the plurality of subsystem models; and
generating at least one system model having at least one predetermined limit by integrating the plurality of subsystem models, wherein at least one of the subsystem models is bounded by at least one of the following:
at least one predetermined limit of at least one other subsystem model; and
at least one predetermined limit of the system model.

9. A method in accordance with claim 8 wherein generating at least one system model having at least one predetermined limit by integrating the plurality of subsystem models comprises:
generating a first subsystem model of a first subsystem having a first predetermined limit;
generating a first subsystem model of a second subsystem having a second predetermined limit; and
generating a second subsystem model of the first subsystem having a third predetermined limit.

10. A method in accordance with claim 9 further comprising at least one of:
generating a second subsystem model of the second subsystem having a fourth predetermined limit; and
generating the system model having a system model predetermined limit.

11. A method in accordance with claim 10 further comprising iteratively generating the plurality of subsystem models and the at least one system model with predetermined limits.

12. A method in accordance with claim 8 wherein generating a plurality of subsystem models comprises:
at least partially forming a system health monitoring scheme;
coupling at least one input channel and one output channel in data communication with each subsystem;
coupling each input channel and each output channel in data communication with the system health monitoring scheme that includes the plurality of subsystem models; and
receiving a first input signal via each of the input signal conduits and a first output signal via each of the output signal conduits within the process health monitoring scheme.

13. A method in accordance with claim 8 further comprising:
transmitting a second input signal via each of the input signal conduits and a second output signal via each of the output signal conduits to a system health monitoring scheme that includes the plurality of subsystem models;
comparing each of the second input signals and each of the second output signals within the plurality of subsystem models; and
generating at least one notification signal if comparing the signals with the plurality of subsystem models indicates a variance exceeding a predetermined value.

14. A method in accordance with claim 13 further comprising forming at least one statistical process control algorithm within the system health monitoring scheme configured to enhance an information content of the at least one notification signal.

15. A method in accordance with claim 8 wherein coupling at least one machine learning scheme in data communication with at least one of a system model comprises configuring and training the at least one machine learning scheme to decrease a number of false predictions.

16. A system health monitor comprising:
a plurality of subsystem models formed to at least partially represent each of a plurality of subsystems, wherein a first subsystem model has a first predetermined limit and a second subsystem model has a second predetermined limit; and
at least one system model at least partially formed by said plurality of subsystem models, wherein said at least one system model at least partially represents a system formed by said plurality of subsystems, said at least one system model has a third predetermined limit, wherein the first predetermined limit, the second predetermined limit, and the third predetermined limit cooperate to form at least one of:
a fourth predetermined limit of said first subsystem model;
a fifth predetermined limit of said second subsystem model; and
a sixth predetermined limit of said system model.

17. A system health monitor in accordance with claim 16 further comprising at least one system and subsystem model module configured to form said at least one system model and said plurality of subsystem models.

18. A system health monitor in accordance with claim 16 further comprising at least one comparison module comprising at least one comparison algorithm, said at least one comparison module is coupled in data communication with at least one system input conduit and at least one system output conduit and is configured to receive at least one system input and at least one system output.

19. A system health monitor in accordance with claim 16 further comprising at least one machine learning scheme coupled in data communication with at least one of:
at least one system and subsystem model module;
at least one comparator module;
at least one statistical process control module; and
at least one alert module.

20. A system health monitor in accordance with claim 19 wherein said at least one machine learning scheme is configured to facilitate a veracity and an accuracy of at least one predictive failure notification.
